(19) United States
(12) Patent Application Publication
(10) Pub. No.: US 2015/0053490 A1
(43) Pub. Date: Feb. 26, 2015

(54) BATTERY POWERED ALL TERRAIN WHEELCHAIR

(71) Applicant: Amy Green Santagata, Hoover, AL (US)

(72) Inventor: Amy Green Santagata, Hoover, AL (US)

(21) Appl. No.: 14/468,027

(22) Filed: Aug. 25, 2014

Related U.S. Application Data
(60) Provisional application No. 61/869,725, filed on Aug. 25, 2013.

(51) Int. Cl. A61G 5/06; A61G 5/04

(52) U.S. Cl. CPC A61G 5/06; A61G 5/045; A61G 2005/1051
USPC 180/65.1

(57) ABSTRACT

A battery powered all terrain wheelchair includes a frame comprising a front portion, a rear portion, sides, a top portion and a bottom portion. A seat attaches to the top portion of the frame. At least one battery attaches to the frame. At least one motor attaches to the frame. The at least one motor is powered by the at least one battery. A controller, powered by the at least one battery, connects to the at least one motor. A plurality of caster assemblies attaches to the bottom portion of the frame. A plurality of wheels attaches to the plurality of caster assemblies including a set of rear wheels that are independently connected to the at least one motor.

### CROSS-REFERENCE TO RELATED APPLICATION

This application claims the benefit of U.S. provisional application number 61/869,725, filed Aug. 25, 2013, the contents of which are herein incorporated by reference.

### BACKGROUND OF THE INVENTION

The present invention relates to wheelchairs and, more particularly, to battery powered all terrain wheelchairs.

The inability for the disabled or mobility challenged to traverse the same terrain as able bodied persons is a problem that many must face. Currently, items have limited ground clearance, do not have four wheel independent suspensions, or use tracks instead of tires. These items cannot traverse all terrains. Other items may be loud in volume.

As can be seen, there is a need for a battery powered all terrain wheelchair with independent suspension and individual motors controlling each rear wheel.

### SUMMARY OF THE INVENTION

In one aspect of the present invention, a battery powered all terrain wheelchair comprises: a frame comprising a front portion, a rear portion, sides, a top portion and a bottom portion; a seat attached to the top portion of the frame; at least one battery attached to the frame; at least one motor attached to the frame, wherein the at least one motor is powered by the at least one battery; a controller connected to the at least one motor, wherein the controller is powered by the at least one battery; a plurality of caster assemblies attached to the bottom portion of the frame; and a plurality of wheels attached to the plurality of caster assemblies, wherein the plurality of wheels are connected to the at least one motor.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention;

FIG. 2 is a side perspective view of an exemplary embodiment of the present invention;

FIG. 3 is a rear perspective view of an exemplary embodiment of the present invention;

FIG. 4 is a detail perspective view of a front suspension unit of an exemplary embodiment of the present invention;

FIG. 5 is a front perspective view of an alternate embodiment of the present invention;

FIG. 6 is a rear perspective view of an alternate embodiment of the present invention;

FIG. 7 is a bottom perspective view of an alternate embodiment of the present invention;

FIG. 8 is a front perspective view of a caster assembly of an alternate embodiment of the present invention;

FIG. 9 is a front perspective view of an armrest assembly of an alternate embodiment of the present invention;

FIG. 10 is a rear perspective view of an armrest assembly of an alternate embodiment of the present invention;

FIG. 11 is a detail section view of a rear wheel and hub assembly of an alternate embodiment of the present invention;

FIG. 12 is a front perspective view of a second alternate embodiment of the present invention;

FIG. 13 is a rear perspective view of a second alternate embodiment of the present invention;

FIG. 14 is a bottom perspective view of a second alternate embodiment of the present invention;

FIG. 15 is a front perspective view of a caster assembly of a second alternate embodiment of the present invention;

FIG. 16 is a front perspective view of an armrest assembly of a second alternate embodiment of the present invention;

FIG. 17 is a rear perspective view of an armrest assembly of a second alternate embodiment of the present invention; and

FIG. 18 is a rear perspective view of a swing arm assembly of a second alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a battery powered all terrain wheelchair that includes a frame comprising a front portion, a rear portion, sides, a top portion and a bottom portion. A seat attaches to the top portion of the frame. At least one battery attaches to the frame. At least one motor attaches to the frame. The at least one motor is powered by the at least one battery. A controller, powered by the at least one battery, connects to the at least one motor. A plurality of caster assemblies attaches to the bottom portion of the frame. A plurality of wheels attaches to the plurality of caster assemblies including a set of rear wheels that are independently connected to the at least one motor. The present invention may allow wheelchair users to be able to travel over various terrains such as sand, trail riding, and the like.

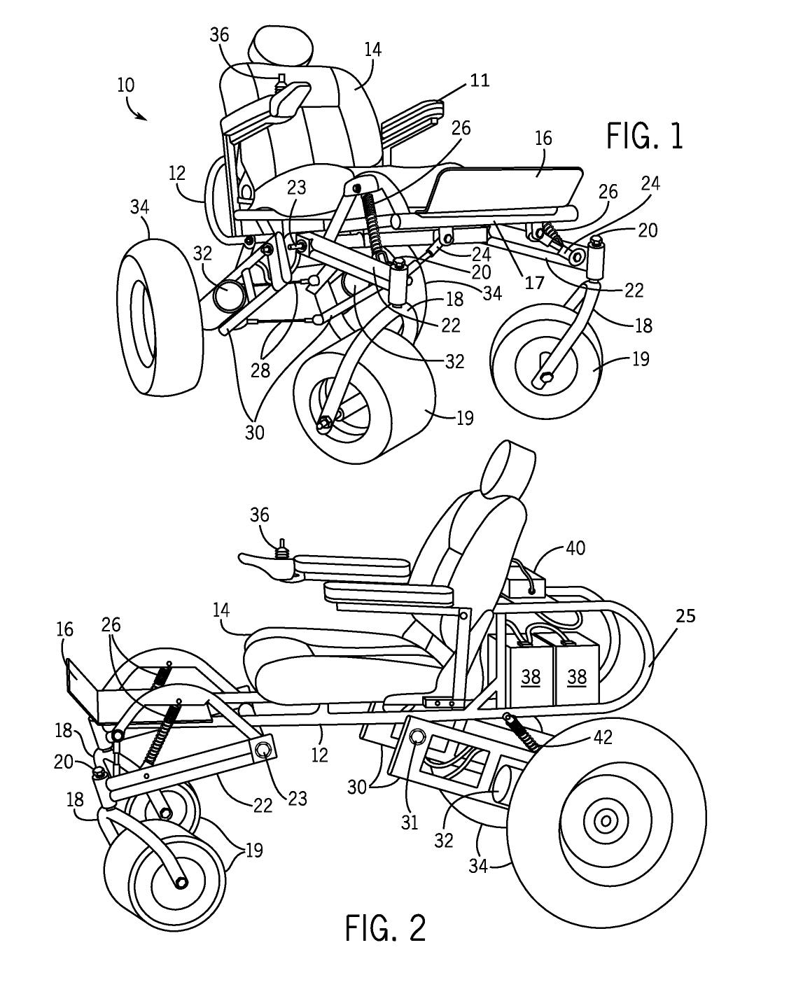

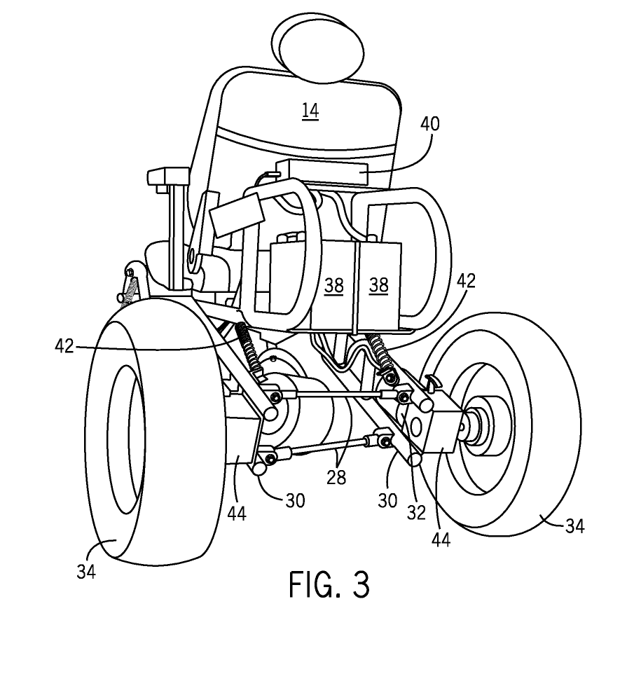

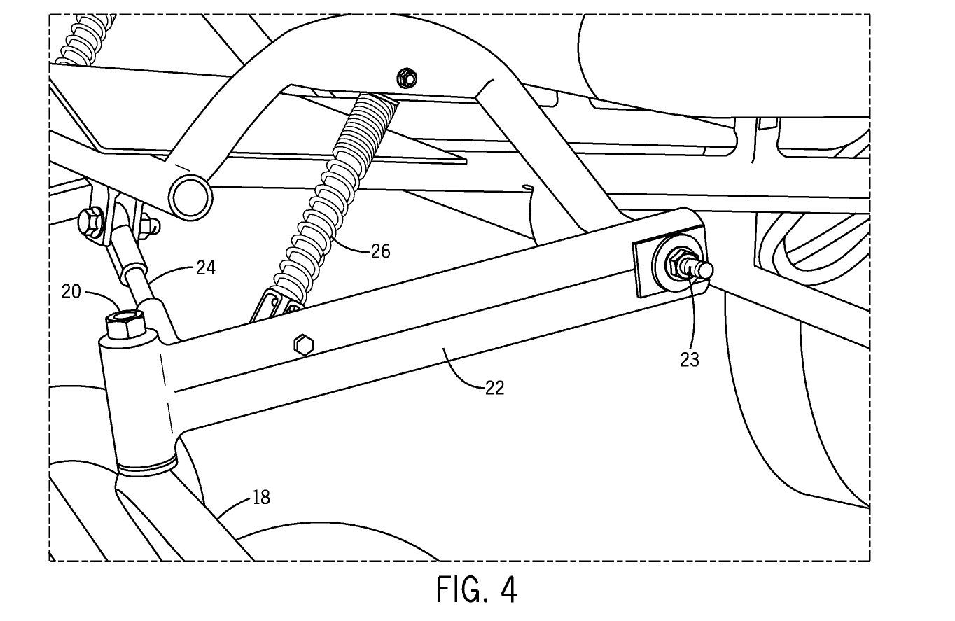

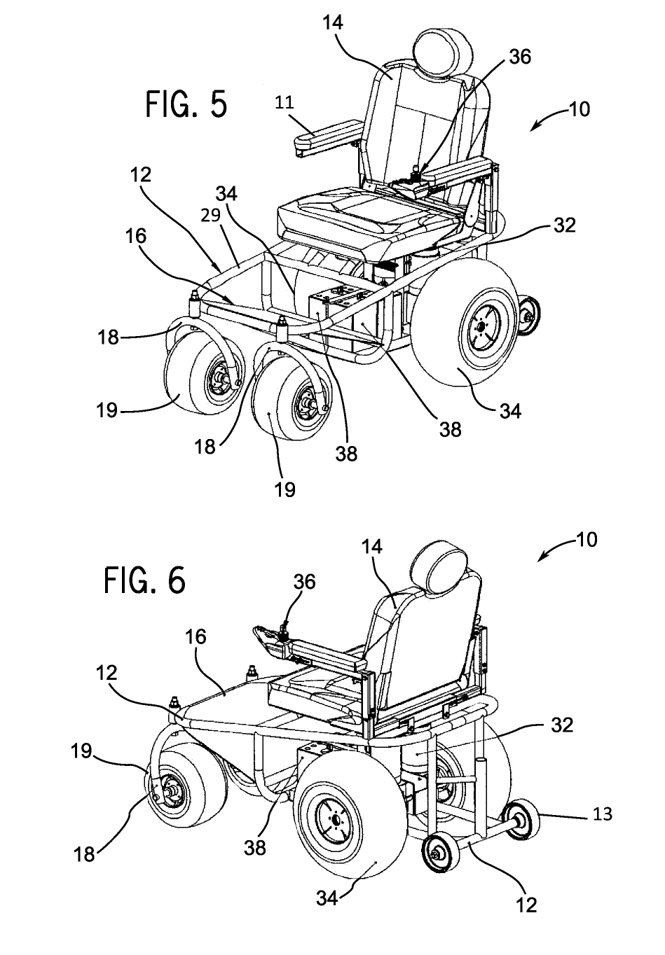

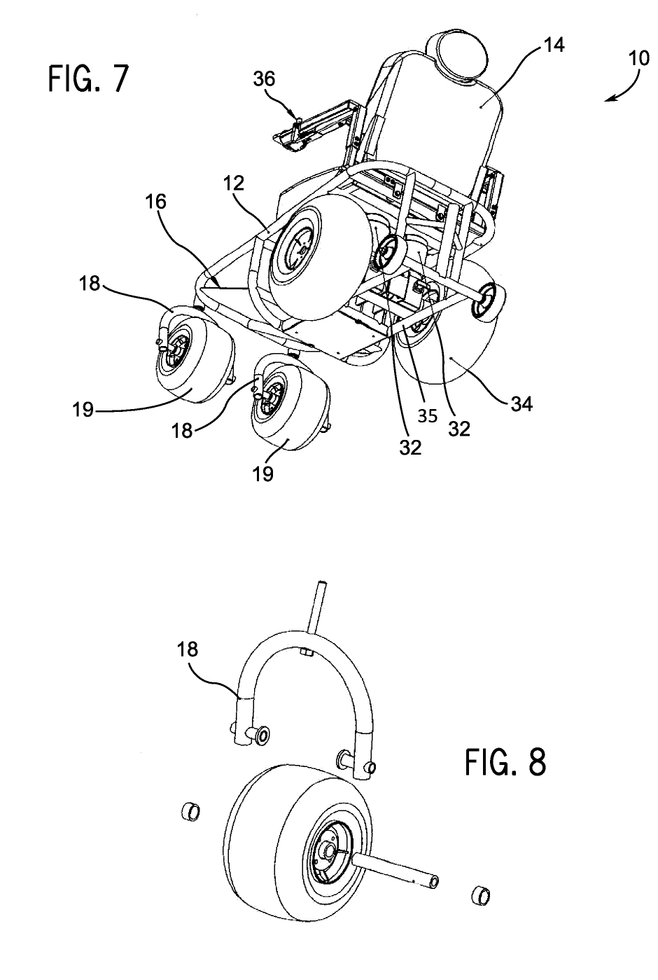

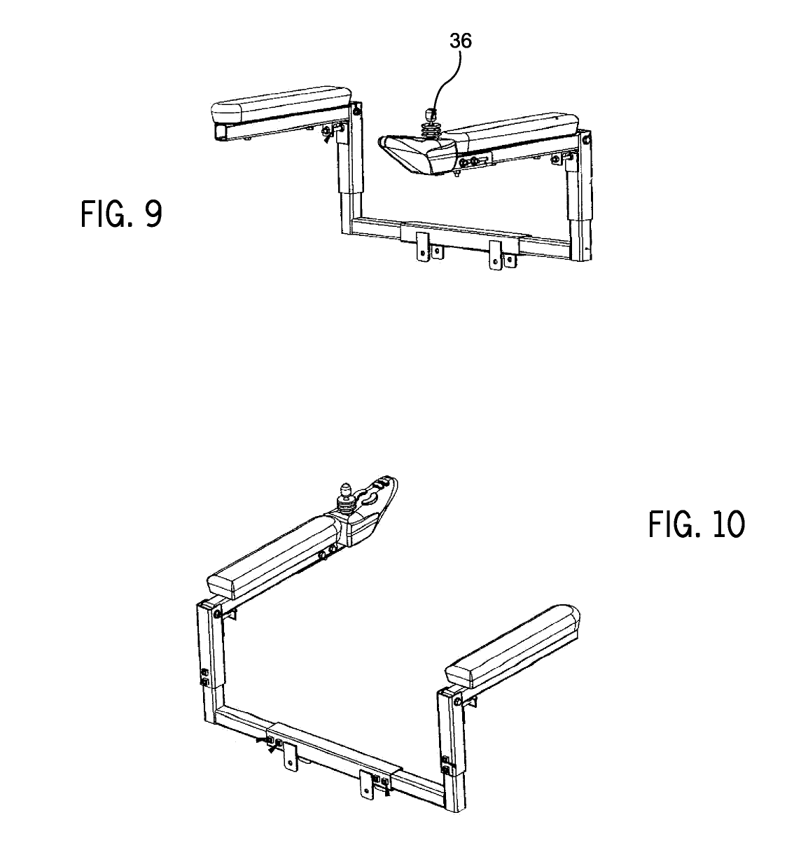

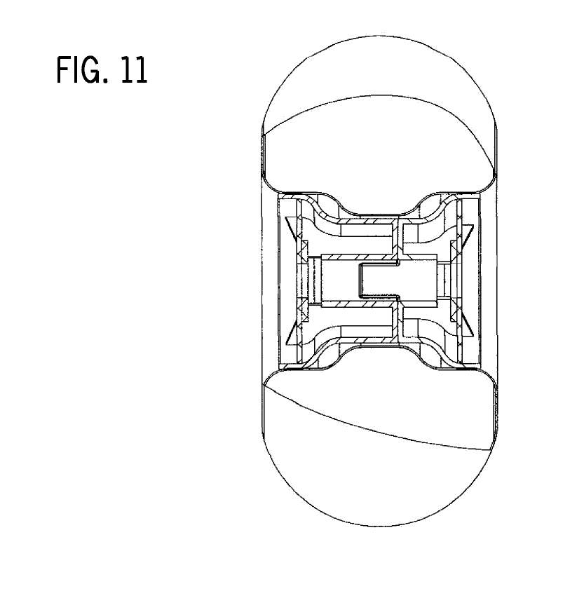

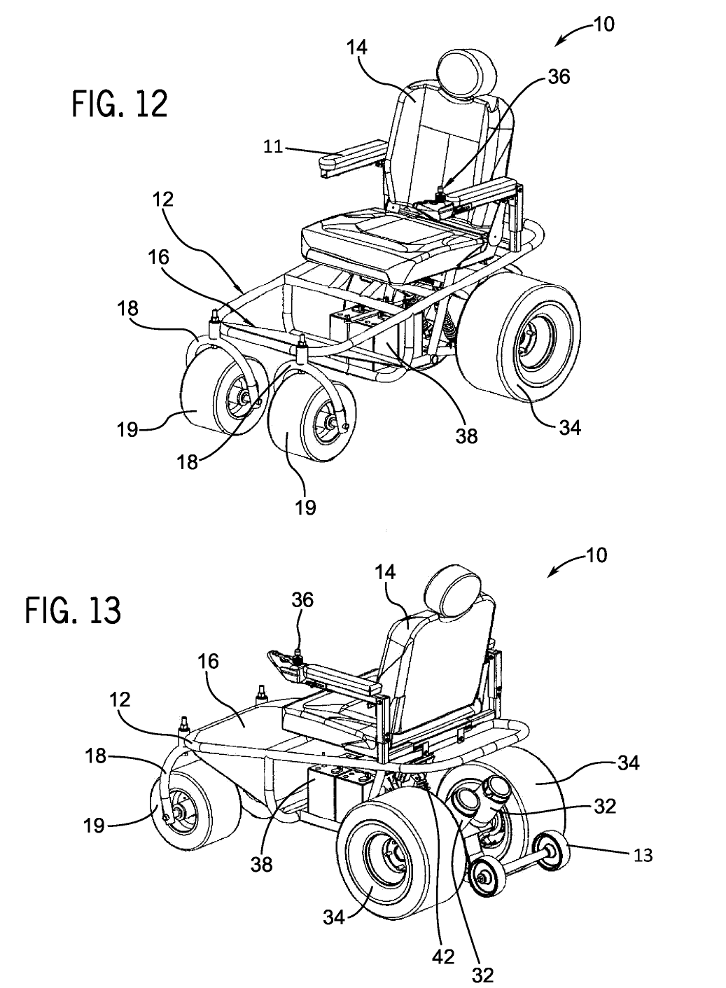

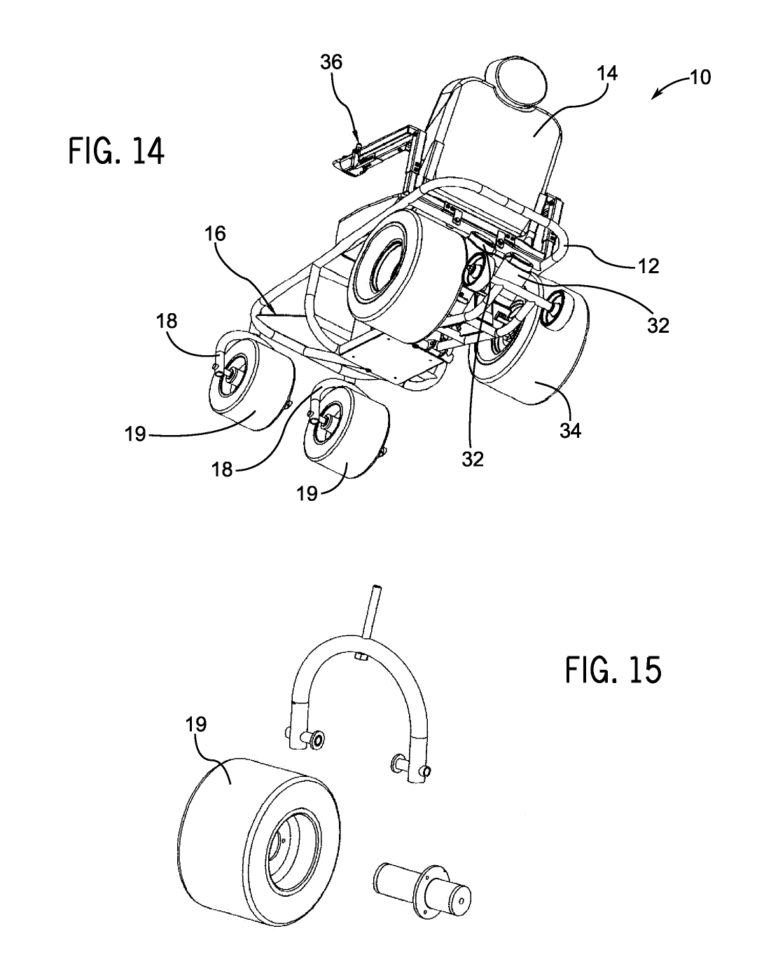

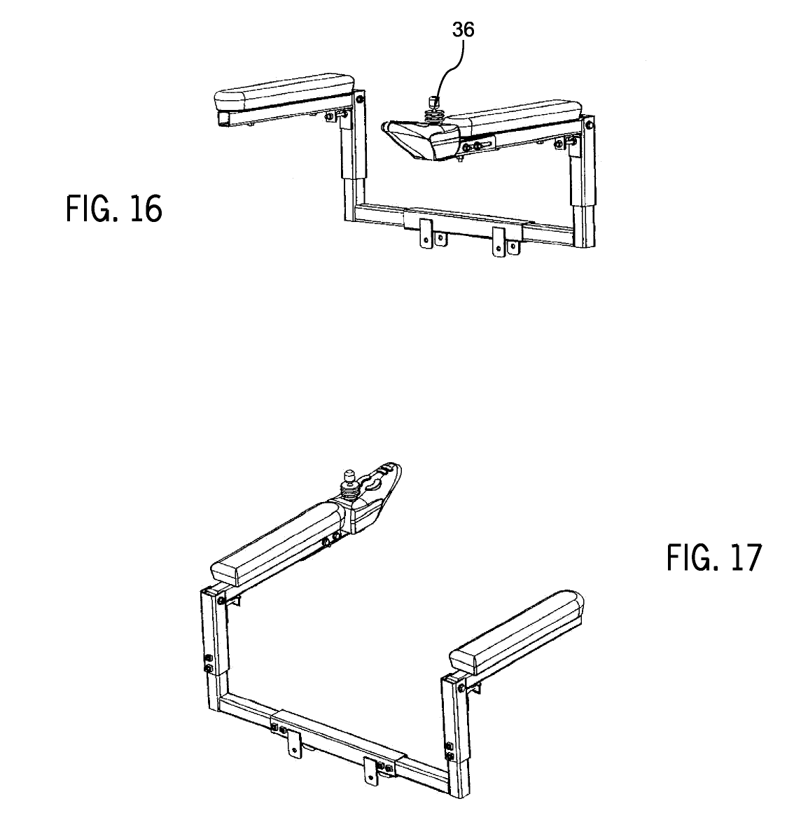

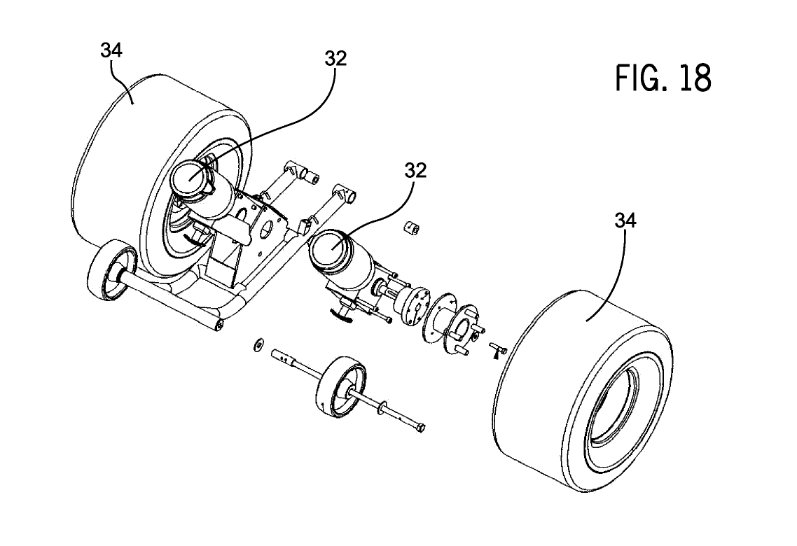

As illustrated in FIGS. 1 through 18, a battery powered all terrain wheelchair 10 may include a frame 12. The frame 12 may include a front portion 17, a rear portion 25, sides, a top portion 29, and a bottom portion 35. A seat 14 may attach to the top portion 29 of the frame 12. At least one battery 38 may be attached to the frame 12. At least one motor 32 may be attached to the frame, wherein the at least one motor 32 may be powered by the at least one battery 38. The at least one motor 32 may be controlled by a controller 36. The controller 36 may be a joystick attached to the frame 12. An armrest assembly 11 may attach to the frame 12 and the seat 14. The controller 36 may be positioned along the armrest assembly 11 attached to the frame 12. A plurality of caster assemblies 18 may attach to the bottom portion 35 of the frame 12. In certain embodiments, each caster assembly 18 may attach to a swing arm, such as a front swing arm 22 or a rear swing arm 30, where the swing arm may attach to the frame 12. Each front swing arm 22 may have a front pivot swing arm 23 and a castor pivot 20 attached. Each rear swing arm 30 may have a rear pivot swing arm 31. At least one stability system may attach to the bottom portion 35 of the frame 12. The stability system may include at least one front stabilizer 24, at least one front shock absorber 26, at least one rear stabilizer 28, and at least one rear shock absorber 42. A plurality of wheels may be attached to the plurality of caster assemblies 18. In certain embodiments, the plurality of wheels may include a set of front wheels 19 and a set of rear wheels 34. In certain embodiments, the set of front wheels 19 may attach to the plurality of caster assemblies 18. In certain embodiments, the plurality of wheels may also include a set of aft stabilizer wheels 13 that may be attached to the rear portion 25 of the frame 12. The plurality of wheels may connect to the at least one motor 32. In certain embodiments, only the set of rear wheels 34 may be connected to the at least one motor 32. In certain embodiments, a footrest 16 may be attached to the front portion 17 of the top portion 29 of the frame 12.

In certain embodiments, a battery charger 40 may be attached to the frame 12. A gearbox 44 may be attached to the plurality of wheels. In certain embodiments, the battery charger 40 and the at least one battery 38 may be placed on the top portion 29 of the frame 12 behind the seat 14. The location of the battery charger 40 and the at least one battery 38 on the top portion 29 of the frame 12 may allow for ground clearance. The front stabilizers 24 and the rear stabilizers 28 may provide stability through independent suspension. The at least one motor 32 may operate each rear wheel 34 independently which may allow for mobility and zero radius turning. The front swing arms 22 and caster assemblies 18 may also allow for stability and zero radius turning.

A method of using the wheelchair 10 may include turning on the joystick that may be powered by the at least one battery 38. The joystick may control the power sent to each motor 32 that may move each rear wheel 34 to propel the wheelchair 10 in whatever direction the user may choose to go. The wheelchair 10 may then go over various terrains such as sand, trail riding, gravel, off road, natural area and the like.

In certain embodiments, additional items may be attached to the wheelchair 10 to increase comfort such as a dry storage box, a gun rack, a cup holder, a sound system, a lighting system.

It should be understood, of course, that the foregoing relates to exemplary embodiments of the invention and that modifications may be made without departing from the spirit and scope of the invention as set forth in the following claims.

What is claimed is:

1. A battery powered all terrain wheelchair comprising:
a frame comprising a front portion, a rear portion, sides, a top portion and a bottom portion;
a seat attached to the top portion of the frame;
at least one battery attached to the frame;
at least one motor attached to the frame, wherein the at least one motor is powered by the at least one battery;
a controller connected to the at least one motor, wherein the controller is powered by the at least one battery;
a plurality of caster assemblies attached to the bottom portion of the frame; and
a plurality of wheels attached to the plurality of caster assemblies, wherein the plurality of wheels are connected to the at least one motor.

2. The wheelchair of claim 1, further comprising a footrest attached to the front portion of the top portion of the frame.

3. The wheelchair of claim 1, further comprising a stability system attached to the bottom portion of the frame.

4. The wheelchair of claim 1, further comprising at least one shock absorber attached to the frame.

5. The wheelchair of claim 1, further comprising a battery charger attached to the frame.

6. The wheelchair of claim 1, wherein each castor assembly further attaches to a swing arm, wherein each swing arm attaches to the bottom portion of the frame.

7. The wheelchair of claim 1, wherein the plurality of wheels comprises two front wheels and two rear wheels, wherein the two rear wheels are powered by the at least one motor.

8. The wheelchair of claim 1, wherein the controller is a joystick.

9. The wheelchair of claim 8, further comprising an armrest assembly attached to the frame and the seat, wherein the joystick is positioned along the armrest assembly.
